(19) United States
(12) Patent Application Publication
(10) Pub. No.: US 2017/0200306 A1
(43) Pub. Date: Jul. 13, 2017

(54) CONTROL SYSTEM FOR COORDINATING EARTH-WORKING MACHINES

(71) Applicant: Caterpillar Paving Products Inc., Brooklyn Park, MN (US)

(72) Inventor: John Lee MARSOLEK, Watertown, MN (US)

(73) Assignee: Caterpillar Paving Products Inc., Brooklyn Park, MN (US)

(21) Appl. No.: 14/990,944

(22) Filed: Jan. 8, 2016

(51) Int. Cl. G06T 17/05; E02F 9/26; G05D 1/02; E02F 9/20

(52) U.S. Cl. CPC G06T 17/05; E02F 9/2054; E02F 9/262; E02F 9/205; G05D 1/0291; G05D 2201/0202

(57) ABSTRACT

A control system for coordinating a plurality of machines for performing a plurality of types of earth-working operations on a worksite is disclosed. The control system may include a plurality of locating devices, each being configured to generate a signal indicative of a three-dimensional location of one of the plurality of machines and being associated with one of the plurality of types of earth-working operations, a display device, and a controller in electronic communication with the plurality of locating devices and the display device. The controller may be configured to determine a surface condition of the worksite based on the signal generated by each of the plurality of locating devices and corresponding to one or more of the plurality of types of earth-working operations. The controller may also be configured to generate a map of the worksite on the display device indicative of the surface condition of the worksite.

### TECHNICAL FIELD

The present disclosure relates generally to a control system and, more particularly, to a control system for coordinating earth-working machines.

### BACKGROUND

Paved roadways, such as concrete- and asphalt-surfaced roads, are built to facilitate vehicular travel. Paved roadways generally consist of a surface course (e.g., concrete or asphalt) that is supported by a base layer and/or a subbase layer of aggregate material deposited on a subgrade of native earth material. At the beginning of a road-building operation, the subgrade is prepared through a number of earth working processes that are designed to improve the workability of the subgrade, redistribute subgrade material, set the slope of the subgrade, and increase the density of the subgrade material prior to paving. These earth-working operations are performed to achieve longer lasting and better performing roadways that can withstand greater loads over time and varying conditions.

In many instance, several different types of earth-working machines are involved in the process of preparing a subgrade prior to paving. Such machines typically include rotary mixers for mixing and stabilizing subgrade materials, dozers for redistributing material, motor graders for finishing the subgrade surface and setting its slope, and compactors for increasing the density of the subgrade to improve its load bearing capability. Each type of machine is used in succession to perform a particular task having certain production goals that partially define an overall design plan or design model for the road. However, depending on certain factors, such as the design model of the road, worksite conditions, operator proficiency, and/or other factors, it can be difficult for supervisors to smoothly coordinate the operations of each type of machine while avoiding certain inefficiencies, such as excessive downtime when machines sit idly while the preceding operation is being finished, and the making of inadvertent overlapping or second passes over completed areas.

A system for monitoring the progress of ground-working machines is disclosed in U.S. Pat. No. 5,646,844 that issued to Gudat et al. on Jul. 8, 1997 (“the '844 patent”). In particular, the '844 patent discloses a system for directing the operations of geography-altering machines on a common worksite relative to one another. The system includes a positioning system configured to track the location of a number of compacting machines on a compacting site. The positioning system includes a receiver mounted to each compacting machine and base station near the compacting site that determines the location of the receiver on each machine. Using location signals from the base station in conjunction with known machine geometries, a controller generates a model of the compaction site in terms of elevation and displays the model as a map to an operator via a display device. As each machine moves around the compaction site, the controller receives current data reflecting updated machine positions and modifications to the topography of the compaction site. The controller compares the generated model to a site plan to determine a difference between the site plan and the current state of the compaction site. This difference is shown to the operator via a graphical interface on the display device.

While the system of the '844 patent may allow for operators of compacting machines to visualize their progress and the progress of other compacting machines on the same jobsite with respect to elevation, improvements to machine tracking and communication systems may yet be realized to further streamline the coordination of different machine processes and increase operational efficiency.

The control system of the present disclosure solves one or more of the problems set forth above and/or other problems in the art.

### SUMMARY

In one aspect, the present disclosure is related to a control system for coordinating a plurality of machines for performing a plurality of types of earth-working operations on a worksite. The control system may include a plurality of locating devices, each being configured to generate a signal indicative of a three-dimensional location of one of the plurality of machines, the signal being associated with one of the plurality of types of earth-working operations. They control system may further include a display device and a controller in electronic communication with the plurality of locating devices and the display device. The controller may be configured to determine a surface condition of the worksite based on the signal generated by each of the plurality of locating devices and corresponding to one or more of the plurality of types of earth-working operations. The controller may also be configured to generate a map of the worksite on the display device, wherein the map is indicative of the surface condition of the worksite.

In another aspect, the present disclosure is related to a method of coordinating a plurality of machines for performing a plurality of types of earth-working operations on a worksite. The method may include receiving a plurality of signals, each being indicative of a three-dimensional location of one of the plurality of machines and associated with one of the plurality of types of earth-working operations, determining a surface condition of the worksite corresponding to one or more of the plurality of types of earth-working operations based on the plurality of signals, and generating a map of the worksite on a display device, wherein the map is indicative of the surface condition of the worksite.

In yet another aspect, the present disclosure is directed to a control system for coordinating a plurality of machines for performing a plurality of types of earth-working operations on a worksite. The control system may include a plurality of locating devices, each being configured to generate a signal indicative of a three-dimensional location of one of the plurality of machines, the signal being associated with one of the plurality of types of earth-working operations. The control system may further include a display device and a controller in electronic communication with the plurality of locating devices and the display device. The controller may be configured to generate a three-dimensional as-built model of the worksite based on the signal generated by each of the plurality of locating devices and determine a difference between the as-built model and a design model of the worksite stored in memory of the controller. The controller may be further configured to determine a surface condition of the worksite based on the difference between the as-build model and the design model, the surface condition corresponding to one or more of the plurality of types of earth-working operations. The controller may be further configured to determine a grade status of the worksite based on the difference between the as-built model and the design model, generate a map of the worksite on the display device, wherein the map is indicative of the surface condition and the grade status of the worksite, and generate graphical objects on the map indicative of areas of the worksite where each of the plurality of types of earth-working operations were respectively performed by the plurality of machines.

### BRIEF DESCRIPTION OF THE DRAWINGS

FIG. 1 is a pictorial illustration of an exemplary worksite of an earth-working operation having a plurality of earth-working machines;

FIG. 2 is a diagrammatic illustration of an exemplary disclosed control system that may be used to coordinate the operations of the machines of FIG. 1;

FIG. 3 is a diagrammatic illustration of an exemplary disclosed controller that may be used with the control system of FIG. 2; and

FIG. 4 is a pictorial illustration of an exemplary disclosed graphical user interface that may be generated by the controller of FIG. 3.

### DETAILED DESCRIPTION

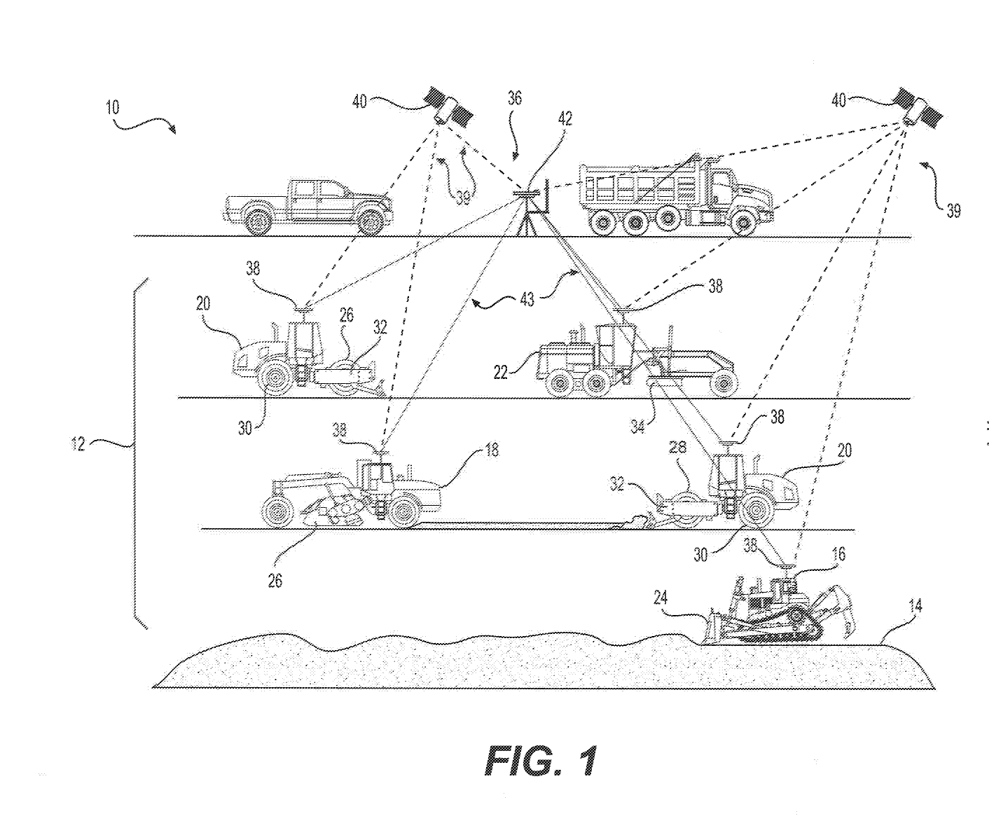

FIG. 1 shows an exemplary worksite 10 where a plurality of machines 12 are employed to perform an earth-working operation, such as preparing a subgrade 14 for a road bed. However, it is understood that the same or different types of machines may be used to perform other operations, such as paving operations, mining operations, agricultural operations, etc. Preparing subgrade 14 may involve completing a plurality of different earth-working operation according to a planned design model of the finished road. Each machine 12 may be assigned a task that involves completing at least a portion of one of the plurality of different earth-working operations based on the types of operations that each machine 12 is configured to perform. In this way, each machine 12 may be associated with one of the plurality of earth-working operations.

For example, machines 12 may include one or more dozers 16, rotary mixers 18, compactors 20 and/or motor graders 22 (only one dozer 16, rotary mixer 18, and motor grader 22 are shown). It is understood that other types of machines may be used. Dozers 16 may be tracked or wheeled machines equipped with a dozer blade 24 and configured to push material from one area of worksite 10 to another. Dozers 16 may be used to perform various tasks, such as relocating or distributing large amounts of material, shaping embankments, and setting rough grades or slopes of subgrade 14. In general, dozers 16 may be larger than other earth-working machines used during the formation of subgrade 14 and may therefore be relied on to move larger amounts of material in shorter amounts of time.

Rotary mixers 18 may be wheeled machines equipped with a rotary tool 26 that is configured to break up native soil or another type of surfaces. As rotary mixer 18 travels across worksite 10, rotary tool 26 may cut into the work surface at a certain depth to break up the surface, pull up material from below the surface, and mix the material into a loose and uniformly-consistent mixture. To improve the strength of subgrade 14, a stabilizing material may be added to the native soil prior to mixing. For example, calcium oxide, may be spread over the native soil and sprayed with water prior to operating rotary mixers 18. When wetted, the calcium oxide may react to form calcium hydroxide, which may then be mixed into the native soil by rotary tool 26. Minerals in the native soil may react with the calcium hydroxide to form mineral hydrates that can improve the strength and durability of subgrade 14.

Compactors 20 may be wheeled machines equipped with compacting tools 28 configured to compact the material beneath them. As shown in FIG. 1, compactor 20 may be supported on the work surface and propelled via a plurality of wheel assemblies 30 (e.g., a rim and a tire—only one shown) operatively connected to and driven by a power source (e.g., an engine). Compacting tool 28 may be rotationally connected to a frame 32 and also configured to support compactor 20 on the work surface. In this way, compactor 20 may be driven forward on wheel assemblies 30 and compacting tool 28.

In some embodiments, compacting tool 28 may be a drum having a smooth outer surface configured to engage and compact the work surface. The drum may include an internal vibratory system comprising one or more eccentric weights driven by motors. In other embodiments, compacting tool 28 may be part of wheel assembly 30. For instance, wheel assembly 30 may include a cylindrical drum (i.e., instead of a rim and tire) connected to an axle driven by the power source. A number of wheel tips may also be connected to an exterior of the drum that extend radially outwardly and press into the work surface as the wheel assembly rotates. Other configurations of compactors 20 and compacting tools 28 may be used, as desired. Compactors 20 may be driven over the loose soil following the mixing process performed by rotary mixer 18 or after the final grade or slope of subgrade 14 has been set to compact the native soil and increase its density.

Motor graders 22 may be wheeled machines equipped with one or more work tools for performing various tasks, such as redistributing material, cutting ditches, or setting fine grades of subgrade 14. Work tools may include, for example, an adjustable moldboard 34 attached to a drawbar frame for setting the grade or slope of subgrade 14, a front-mounted push plate or dozer blade for moving material, a front- or rear-mounted scarifier for breaking up material, and/or other types of work tools. For instance, motor grader 22 may be driven across subgrade 14 with moldboard 34 adjusted to a desired angle for cutting a particular slope into subgrade 14 in accordance with the design model after the native soil has been shaped, stabilized, and at least partially compacted.

A location of each machine 12 on worksite 10 may be tracked by a positioning system 36 configured to determine the two- or three-dimensional location of each machine 12 with respect to a global or local coordinate system. For example, positioning system 36 may include a plurality of locating devices 38, each being configured to receive positioning signals 39 from a plurality of satellites 40 associated with a global navigation satellite system (GNSS), such as Navstar Global Positioning System (GPS), GLONASS, Galileo, Beidou, etc. Each locating device 38 may use positioning signals 39 to determine its own position (e.g., by trilateration) with respect to the coordinate system. Each locating device 38 may also be attached to one of machines 12 and configured to generate a signal indicative of the location of the machine 12.

In some embodiments, the positioning system 36 may also include a base station 42 at or near worksite 10 that is configured to generate correction data that may be used to more accurately determine the position of locating devices 38 and machines 12. Base station 42 may be configured to receive positioning signals 39 from satellites 40 and generate correction data 43 for correcting errors associated with positioning signals 39 (e.g., relating to satellite clock data, ephemerides, and ionospheric and tropospheric delays). Base station 42 may broadcast the correction data as well as its own position, and locating devices 38 may receive the correction data and use it to more accurately determine their own locations. Locating devices 38 may also use the correction data and the known location of base station 42 to generate elevation data, which may be used to determine the three-dimensional locations of machines 12.

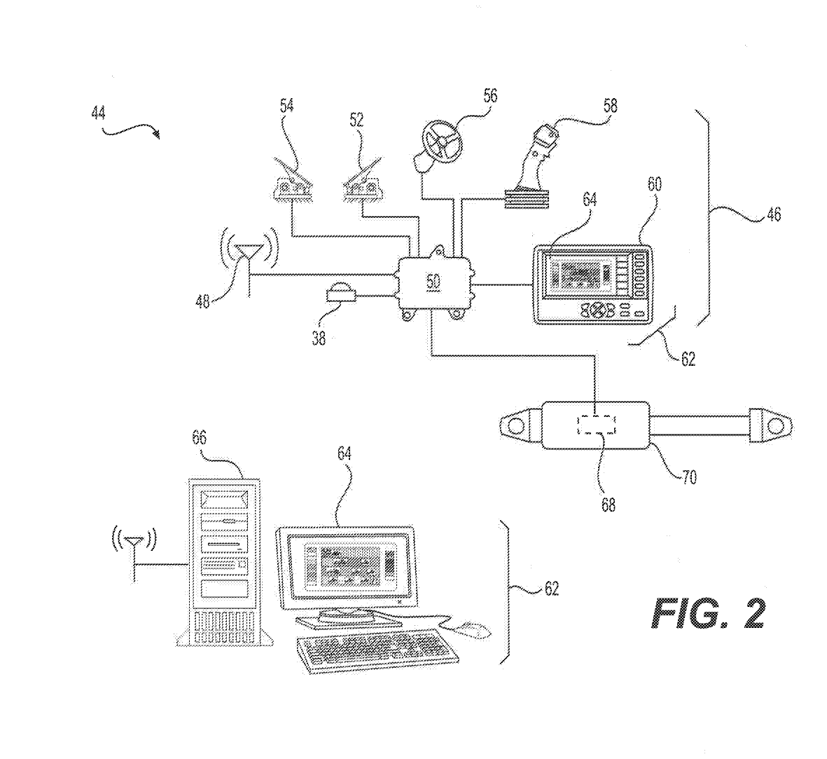

As shown in FIG. 2, each machine 12 (referring to FIG. 1) may include a control system 44 configured to facilitate manual and/or automatic control of the associated machine 12. Control system 44 may include several components, such as, for example, locating device 38, one more interface devices 46 configured to receive inputs from and/or provide information to operators and/or site managers for controlling machines 12, a communication device 48 for sending and receiving data and information, and a controller 50 electronically connected to each of the other components. It is understood that control system 44 may include other or additional components.

Interface devices 46 may include devices that may be located onboard machines 12 (e.g., in an operator station) or off-board that are configured to be used by personnel to control the operations of machines 12. For example, interface devices 46 may include machine controls, such as an accelerator 52 for controlling the speed of machine 12, a brake 54 for controlling the deceleration machine 12, a steering device 56 for controlling the travel direction of machine 12, and a tool control 58 for controlling one or more tool positions and/or orientations. Although each machine control is shown in FIG. 2 as a separate device, it is understood that the functions of multiple machine controls may be incorporated into a single device, such as a single joystick or electronic control device.

Interface devices 46 may also include a multi-functional control device 60 configured to receive information from and provide information to personnel for controlling machines 12. For example, control device 60 may include one or more input devices 62, such as buttons, soft keys, keyboards, a mouse, touch screens, etc., for receiving inputs from personnel indicative of information or requests for information relating to machines 12. Control device 60 may also include a display device 64, such as an LED, LCD, CRT, or other type of display device configured to show information receive signals and show information to personnel associated with the signals. In some embodiments, control device 60 may be an off-board entity, such as an off-board computer 66 that includes input device 62 and display device 64 and is configured to include or communicate with controller 50. Off-board computer 66 may be a desktop computer, a laptop computer, or a mobile device, such as a cellular phone, a tablet, a specialized computing device, or another type of electronic device.

Communication device 48 may include hardware and/or software that enables sending and receiving of data messages between machines 12 and off-board entities (e.g., other machines 12, off-board electronic devices, etc.). The data messages may be sent and received via a direct data link and/or a wireless communication link, as desired. The direct data link may include an Ethernet connection, a connected area network (CAN), or another data link known in the art. The wireless communications may include one or more of satellite, cellular, Bluetooth, WiFi, infrared, and any other type of wireless communications that enables communication device 48 to exchange information.

In some embodiments, control system 44 may also include one or more sensors 68 (only one shown), each being associated with an actuator 70 of machine 12. Sensors 68 may generate signals indicative an actuator position that may be used to determine other information about machines. For example, sensors 68 may generate signals indicative of an extension length of an actuator, a rotational position of an actuator, and/or other information. The signals generated by sensors 68 may be used to determine distances and/or angles between different components of machines 12 or distances and/or angles between components of machines 12 and the work surface. In some instances, actuator 70 may be an actuator controlled by input received from one or more interface devices 46, such as a throttle actuator, a braking device, steering linkage, or an actuator for a work tool (e.g., 24, 26, 28, 34—referring to FIG. 1). For example, sensors 68 may be configured to generate tool position data indicative of a position of a work tool with respect to another device or feature of a respective one of machines 12, such as a frame, a traction device (e.g., a wheel, a track, etc.), or locating device 38. In this way, control system 44 may be configured to track the movements and usage of tools during operation.

Controller 50 may embody a computing device having a single microprocessor or multiple microprocessors and a means for monitoring inputs from other components of control system 44 and generating output signals based on the inputs. For example, controller 50 may include a memory, a secondary storage device, a clock, and a processing hardware for accomplishing a task consistent with the present disclosure. Numerous commercially available microprocessors can be configured to perform the functions of controller 50. It should be appreciated that controller 50 could readily embody a general machine controller capable of controlling numerous other machine functions. Various other known circuits may be associated with controller 50, including signal-conditioning circuitry, communication circuitry, and other appropriate circuitry. Controller 50 may be further communicatively coupled with an external computer system, instead of or in addition to including a computer system, as desired.

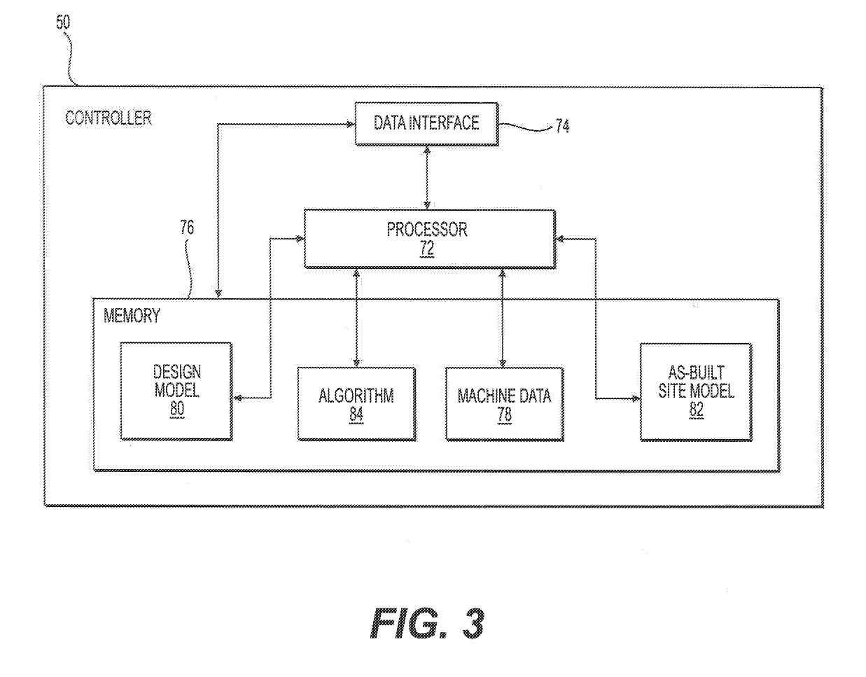

In one example, as shown in FIG. 3, controller 50 may include a processor 72 configured to communicate with other components of control system 44 via a data interface 74. Data interface 74 may include hardware, software, or a combination thereof that is configured to receive electronic signals from other devices and transfer them to processor 72 and/or a memory associated with controller 50. Memory 76 may be configured to store information received from other components of control system 44 via data interface 74, as well as other information relating to machines 12 and worksite 10.

For instance, memory 76 may be configured to store machine data 78 received via data interface 74. Machine data 78 may include information received from locating devices 38 (e.g., locations of machines 12), information received from sensors 68 (e.g., tool positions, settings, etc.), and information received from other machines 12 and/or off-board entities via communication device 48. Machine data 78 may include, for example, list of machines 12 on worksite 10, a machine ID that serves as a unique identifier for a particular machine and is associated with data generated by or transferred from the particular machine. Each machine ID may also be indicative of or associated with a machine type (e.g., dozer, rotary mixer, compactor, motor grader, etc.). Machine data 78 stored within memory 76 may be associated with and organized by the ID of the particular machine from which the data was received. For instance, location data and data from sensors 68 generated by each machine 12 over a period of operating time may be received by controller 50 and stored as machine data 78 in memory 76 for further processing.

Memory 76 may also be configured to store a design model 80 and an as-built site model 82 of worksite 10. Design model 80 may be a three-dimensional model of worksite 10 that represents the outcome of planned operations to be performed on worksite 10. In other words, design model 80 may be a digital blueprint of worksite 10 that contains dimensions (e.g., widths, lengths, depths, design grades, elevations, etc.) and other information describing subgrade 14 and other aspects of the operation. Design model 80 may be generated using rendering software and imported to controller 50 via data interface.

As-built site model 82 may be a model of worksite 10 generated by processor 72 based on machine data 78 and/or other information, such as a modeling algorithm 84 that is also stored within memory 76. More specifically, as-built site model 82 may be a three-dimensional model of worksite 10 that represents the outcome of operations that have actually been performed by machines 12 on worksite 10. In other words, as-built site model 82 may be a blueprint of the current state of worksite 10. In some embodiments, as-built site model 82 may begin as an initial model of worksite 10 generated with data collected via manual surveying techniques and/or automated surveying means. As operations on worksite 10 are carried out by machines 12, processor 72 may regenerate or update as-built site model 82 using modeling algorithm 84 as changes to worksite 10 are made by machines 12. In this way, controller 50 may be configured to generate as-built site model 82.

During construction of subgrade 14, several of machines 12 may simultaneously perform the same or different types of earth-working operations (e.g., dozing, mixing, grading, compacting, etc.). At times, different earth-working operations that are generally performed in succession using different machines may be performed simultaneously at different areas of worksite 10. For example, while dozer 16 or motor grader 22 operate in a first area, rotary mixer 18 or compactors 20 may simultaneously operate in a second area. When dozer 16 or motor grader 22 finish working in the first area (i.e., has met task specifications consistent with a work plan or design model 80), it may be appropriate for rotary mixer 18 or compactors 20 to begin working in the first area.

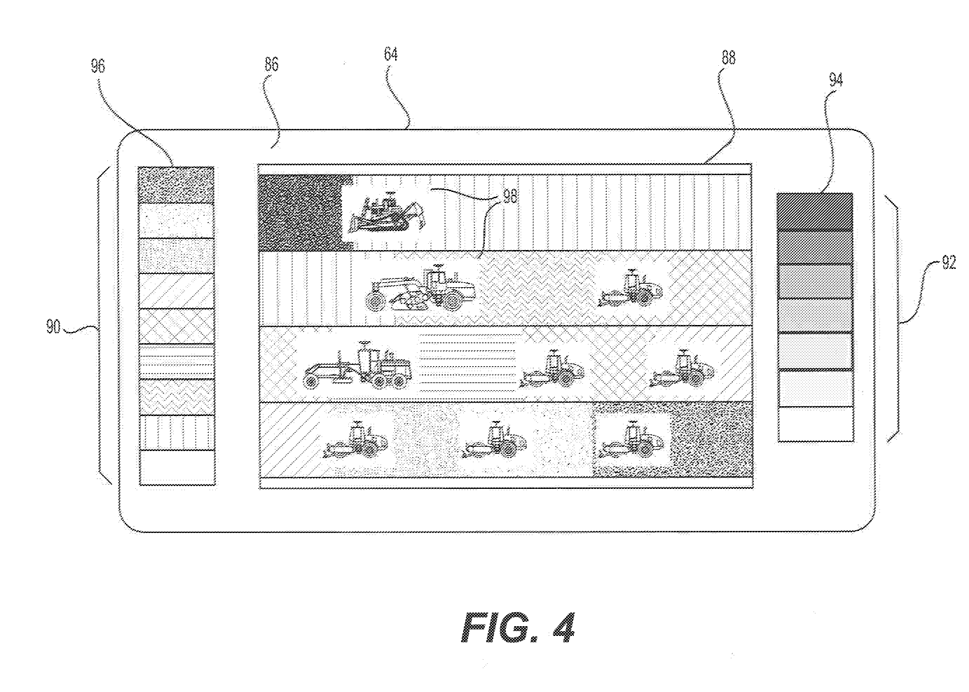

To help operators and managers know when to send machines 12 from one area of worksite 10 to another to carry out certain types of earth-working operations that are consistent with design model 80, controller 50 may be configured to generate a graphical user interface (GUI) 86 on display device 64, as shown in FIG. 4, configured to show a map 88 of worksite 10 that is indicative of where certain types of earth-working operations have been performed and where other types of operations still need to be performed. Map 88 may also be indicative of where worksite 10 does or does not satisfy aspects of design model 80, such as grade specifications.

Controller 50 may generate map 88 based on a surface condition 90 and a grade status 92 of worksite 10. The surface condition 90 of worksite 10 may be an indication of which of a plurality of different earth-working operations (e.g., dozing, mixing, grading, compacting, etc.) was last performed by a particular one of machines 12 (i.e., dozer 16, rotary mixer 18, compactors 20, or motor grader 22). The surface condition 90 of worksite 10 may vary in different areas depending on which earth-working operations were actually performed in each area, and map 88 may reflect this variation.

The grade status 92 of worksite 10 may be an indication of a direction (e.g., high or low) and a degree to which the grade of worksite 10 deviates from design model 80 for a given locational coordinate. That is, grade status 92 may be indicative of where and to what extent worksite 10 should be cut or filled (i.e., where material should be removed or added, respectively) in order to meet the specifications of design model 80. The grade status 92 of worksite 10 may also vary in different areas, and map 88 may reflect this variation.

In generating map 88, controller 50 may be configured to generate as-built site model 82 (referring to FIG. 3) of worksite 10 based on the signal generated by each of the plurality of locating devices 38 and generate map 88 based on a difference between as-built site model 82 and design model 80 stored in memory 76 (referring to FIG. 3). Controller 50 may retrieve from memory 76 or receive directly from locating devices 38 location data of each machine 12 over a period of operating time and use the data to construct as-built site model 82. The location data generated by locating devices 38 may include elevation data in addition to northing and easting data, and controller 50 may be configured to construct as-built site model 82 using the elevation data to provide an indication of the actual location of the surface of subgrade 14.

Controller 50 may also store in memory 76 known distance offsets (e.g., vertical or elevation offsets) of working components (e.g., work tools, wheels, tracks, etc.) from locating device 38 for each machine 12. Using these distance offsets, controller 50 may be configured to use the location of each machine 12 (i.e., the actual location of locating device) to determine where work tools (e.g., dozer blade 24, rotary tool 26, compacting tools 28, moldboard 34, etc.) and/or traction devices (e.g., wheels, tracks, etc.) actually make contact with and/or modify the surface of subgrade 14. In this way, controller 50 may be configured to determine the actual elevation of subgrade 14, which may relieve surveyors from the burden of having to check and recheck the elevation of subgrade 14 during each earth-working operations.

In some embodiments, controller 50 may also retrieve from memory 76 or receive directly from sensors 68 tool position data that corresponds to location data used to generate as-built site model 82 and use the tool position data to more accurately determine the actual elevation of subgrade 14 in determining as-built site model 82. That is, controller 50 may use the tool position data in conjunction with the known location of locating device 38 and known offsets between locating device 38 and the work tool to more accurately determine the actual elevation of subgrade 14. For instance, when one of machines 12 has an adjustable work tool (e.g., dozer blade 24, rotary tool 26, moldboard 34, etc.), the work tool may not always be in a position that engages subgrade 14, and controller may use the tool position data to determine when each machine 12 is actually making changes to subgrade 14. When the work tool of each machine 12 is engaged with subgrade 14, controller 50 may use the tool position data generated by sensors 68 (and in conjunction with known offsets) to more accurately determine how each machine 12 is changing the elevation of subgrade 14.

In this way, controller 50 may be configured to use the location data generated by locating devices 38, the tool position data generated by sensors 68, and known offsets to determine the actual elevation of subgrade 14. Controller 50 may use this information to generate as-built site model 82 to provide an actual three-dimensional representation of worksite 10 and subgrade 14. Using algorithm 84 (referring to FIG. 3) or another type of differencing or modeling algorithm or software, controller 50 may be configured to determine the difference between as-built site model 82 and design model 80 as an indication of how worksite 10 actually deviates from design model 80 in terms of elevation. In determining the difference between as-built site model 82 and design model 80, controller 50 may also determine, based on the IDs of each machine 12 associated with the location data used to generate as-built site model 82, which of machines 12 created the difference. That is, controller 50 may also compare as-built site model 82 to a previous iteration of as-built site model 82 to determine which respective one of machines 12 and which associated earth-working operation was used to create a change to worksite 10. In this way, controller 50 may be configured to determine what work has been done to worksite 10, allowing operator and managers to determine where and what kinds of work remain to be done.

Based on the difference between as-built site model 82 and design model 80, controller 50 may be configured to determine grade status 92 of worksite 10 and generate map 88 of worksite 10 to be indicative of the grade status 92. In determining the difference between as-built site model 82 and design model 80, controller 50 may determine an elevation difference between the two models for each common pair of northing and easting coordinates. The elevation difference may be indicative of where the current elevation of worksite 10 is above, below, or at (e.g., when the difference is zero) the design elevation or design grade of design model 80. The magnitude of the difference may be indicative of the degree to which the current elevation of worksite 10 is actually above or below the elevation of design model 80. Based on the magnitude and direction of the elevation difference, controller 50 may be configured to assign grade status 92 to worksite 10. That is, controller 50 may store in memory 76 a scale for assigning grade status 92 based on the magnitude and direction of the difference between as-built site model 82 and design model 80.

Grade status 92 may be a qualitative indication of where the elevation of worksite 10 is above, at, or below the elevation or grade associated with design model 80. To allow operators and managers to quickly and easily visualize the grade status 92 of worksite 10, controller 50 may be configured to generate graphical objects 94 on map 88 indicative of grade status 92. For example, graphical objects 94 may include areas of varying colors, where the colors correspond to the magnitude and direction of the difference between the elevation of worksite 10 and design model 80. For example, areas colored blue may indicate areas where material should be removed from worksite 10, areas colored red may indicate areas where material should be filled in, and areas colored green may indicate areas where the elevation of worksite 10 is equal to or within a tolerable range of design model 80. Additional shades of different colors may be included between each mentioned color to better indicate the degree to which material should be added or removed in order for worksite 10 to meet grade specifications of design model 80, as desired. It is understood that other types of graphical objects 94 may be used to convey differences in elevation or grade, such as textures, hatching, patterns, and/or other graphical indications.

Controller 50 may also be configured to determine surface condition 90 of worksite 10 based on the signal that is generated by each of the plurality of locating devices 38 and which correspond to one or more of the plurality of types of earth-working operations (e.g., dozing, mixing, grading, compacting, etc.). For instance, in receiving the location signals from locating devices 38, controller may associate each signal with the ID of a respective one of machines 12 (i.e., the machine from which a respective location signal was generated). The ID of each machine 12 may also be associated with a machine type (e.g., dozer, rotary mixer, motor grader, compactor etc.) and a type of earth-working operation (e.g., dozing, mixing, grading, compacting, etc.) performed by the respective machine type. When controller 50 generates as-built site model 82 using the location signals from each of machines 12, controller may also determine which associated machine type and type of earth-working operation was last used to modify worksite 10 (i.e., that generated the location data used to create as-built site model 82). The machine type and type of earth-moving process last used on worksite 10 may be indicative of surface condition 90.

Controller 50 may also generate map 88 of worksite 10 to be indicative of surface condition 90. For example, controller 50 may be configured to generate graphical objects 96 on map indicative of areas of worksite 10 where each of the plurality of types of earth-working operations were respectively performed by the plurality of machines 12. That is, each graphical object 96 may be indicative of which earth-working operation, such as a mixing operation, a dozing operation, a grading operation, a compacting operation, etc., was performed. Each graphical object 96 may include different indicia, such as different hatching, textures, patterns, or other indicia that allow operators and managers to visualize and understand which operations have been performed. It is understood that graphical objects 96 may also or alternatively include color variations, shapes, flashing images, and/or other graphical features that can be used to represent different earth-working operations, as desired.

In some embodiments, graphical objects 96 may be indicative of an extent or degree to which certain earth-working operations have been performed. For instance, controller 50 may be configured to track a number of successive performances of a first type of earth-working operation on at least a portion of worksite 10 based on the location signal generated by each of the plurality of locating devices 38 and determine the surface condition of the worksite based further on the number of successive performances of the first type of earth-working operation. That is, using the location data in conjunction with machine IDs and associated machine types and types of earth-working operations, controller 50 may track how many times a particular machine type performed work on an area of worksite 10. For example, controller 50 may be able to determine how many times a portion of worksite 10 has been compacted by compactors 20 (i.e., a pass count) and generate graphical objects 96 to reflect the pass count. The pass count may be indicated by an associated type of hatching, texture, pattern, color, or other graphical feature, as desired. In this way, operators and managers may be able to ensure that a sufficient number of passes using each type of machine 12 has been made in accordance with a construction plan or design model 80.

In some embodiments, controller 50 may be configured to generate graphical objects 98 on map 88 indicative of the location of each of the plurality of machines 12 on worksite 10. For instance, controller 50 may use the location data in conjunction with the ID and associated machine type of each of machines 12 to generate graphical objects 98 on map 88 in the actual location of each respective machine 12. Each graphical object 98 may be, for example, a graphical image of a particular machine type that allows operators and managers to quickly visualize and understand the type of each machine on map 88 as well as where and what kind of work each machine is performing. Alternatively, graphical objects 98 may be another type of graphical feature, such as a shape, number, ID, or other visual indicia that may allow operators and managers to visualize the type and/or unique identity of each of machines 12 on map 88.

In some embodiments, controller 50 may be configured to automatically generate command signals communicable to one or more actuators 70 for automatically controlling operations of machines 12 based on the surface condition 90 of the worksite. For instance, each actuator 70 may be configured to control an operational aspect of one of machines 12, such as a ground speed, a directional heading, and work tool operations. Based on which type of earth-working operation has been performed in an area of worksite 10 (as indicated by the surface condition 90), controller 50 may be configured to generate command signals to actuators 70 for causing one of machines 12 of an appropriate type to automatically perform the next earth-working operation in that area according to a construction plan or design model 80. The control signals may include signals for causing one of machines 12 to travel to an appropriate location at a desired speed and use its work tool for performing an earth-working operation in order to achieve grade specifications associated with design model 80. The command signals may be sent to any actuator 70 of a particular machine 12, including actuators that are controllable via interface devices 46. In this way, aspects of performing earth-working operations may be partially or entirely automated to relieve operators and managers from certain tasks, allowing them to focus on other operational aspects.

### INDUSTRIAL APPLICABILITY

The disclosed control system may be used with any plurality of machines where coordinating their respective operations on a worksite in an efficient and effective manner is important. A controller within the system may receive location data, including altitude data, for each of the plurality of machines and generate an as-built site model of the worksite based on the location data. The controller may also determine a difference between the as-built site model and a design model, and use the difference to determine a surface condition and/or grade status of the worksite. Based on the surface condition and/or grade status, the controller may generate a map configured to convey the surface condition and/or grade status to an operator of one or more of the machines via a display device. An exemplary operation of control system 44 will now be explained.

At the beginning of a road building operation, surveyors may generate an initial three-dimensional model of worksite 10 in its original state. Personnel may also generate design model 80 that represents the desired final outcome of operations to be performed on worksite 10. The initial model and design model 80 may be loaded into memory 76 of controller 50 through data interface 74 for access by processor 72. At the beginning of earth-working operations on worksite 10, controller 50 may designate the initial model of worksite 10 as a preliminary iteration of as-built site model 82.

Controller 50 may then determine a difference between as-built site model 82 and design model 80 as an indication of work to be performed on worksite 10 in order for worksite 10 to match design model 80. Based on the difference, controller 50 may generate GUI 86 on display device 64 that includes map 88 of worksite 10. Map 88 may include graphical objects 94 and 96 that are configured to show the grade status 92 and surface condition 90, respectively, of worksite 10. Map 88 may also include graphical objects 98 that are indicative of the location of each machine 12 on worksite 10. In this way, operators and manager may be able to quickly and easily visualize what types of operations (if any) have been performed as well as where and what types of operations may still need to be completed.

Machines 12 may then be used to perform various earth-working operations on worksite 10 in accordance with a construction plan and design model 80, such as for constructing subgrade 14. As each of machines 12 is working, location signals generated by locating devices 38 may be communicated to controller 50 and stored in memory 76 in association with the ID, machine type, and type of earth-working operation performed by each respective one of machines 12. Each machine 12 may also communicate to controller 50, among other information, tool position data generated by sensors 68, which may also be associated with a respective one of machines 12. As machines 12 continue to operate, controller 50 may use the data received from each machine to regenerate or update as-built site model 82 to reflect any changes to worksite 10 that have been made by machines 12. As the data is received by controller 50, and as controller 50 regenerates as-built site model 82, controller 50 may also regenerate or update map 88 to reflect the current state of worksite 10 and the locations of each machine 12.

That is, as controller 50 receives data, controller may generate a subsequent iteration of as-built site model 82, re-determine the current difference between as-built site model 82 and design model 80, and regenerate map 88 based on the current difference. In this way, controller 50 may continually update map 88 to reflect the current grade status 92 and surface condition 90 of worksite 10 to give operators and managers a clear indication of what types of operations have been completed, what types of operations are ready to be completed, and the locations of machines 12 available for completing the operations. Operators and managers may use the grade status and surface condition 90 of worksite 10, as displayed on map 88, to determine how to control machines 12 collectively (e.g., where to stage them, when to dispatch them, etc.) and individually (e.g., their individual speeds, headings, work tool settings, etc.) to achieve the grade specifications associated with design model 80 in an efficient and effective manner.

In some situations, controller 50 may automatically generate command signals to relieve operators and managers from the burden of constantly monitoring and commanding the operations of machines 12. For instance, when a first operation, such as a dozing operation has been completed, controller 50 may recognize its completion when the next iteration of as-built model is generated and the surface condition 90 and/or grade status 92 of worksite 10 is determined. Controller 50 may then determine whether any of machines 12 are available, based at least in part on their current locations, to perform a second or subsequent operation, such as a mixing operation. Controller 50 may then select a particular one of machines 12 and generate command signals communicable via communication device 48 and transmit them to that particular machine. Controller 50 may recognize the completion of the second operation during a subsequent iteration of determining as-built site model 82 and determine whether any of machines 12 are available and configured to perform a third operation, such as a grading or compacting operation. Based on the difference between as-built site model 82 and design model 80, controller 50 may generate command signals containing location data, tool commands, and/or other information and communicate them to an appropriate machine for carrying out the third or subsequent operation. In this way, certain aspects of worksite operations may be partially or fully automated, thereby allowing operators and managers to focus their attention on other operational aspects.

Several advantages may be associated with the disclosed control system. For example, because controller 50 may determine grade status 92 and surface condition 90 based on location data received from each of machines 12, controller 50 may be able to more accurately determine locations of worksite 10 where certain specific operations have been performed and to what extent worksite 10 should be further modified in order to match design model 80. Further, because controller 50 may utilize location data in conjunction with tool position data from each of machines 12, controller 50 may more accurately determine when and where certain earth-working operations are actually performed. Additionally, because controller 50 may be configured to generate map 88 with each of graphical objects 94, 96, 98 indicative of grade status 92, surface condition 90, and the location of each machine 12, respectively, operators and managers may be able to quickly and easily determine which operations remain to be performed, which of machines 12 to dispatch to perform the operations, and to which areas of worksite 10 to send machines 12.

It will be apparent to those skilled in the art that various modifications and variations can be made to the disclosed control system without departing from the scope of the disclosure. Other embodiments of the control system will be apparent to those skilled in the art from consideration of the specification and practice of the control system disclosed herein. It is intended that the specification and examples be considered as exemplary only, with a true scope of the disclosure being indicated by the following claims and their equivalents.

What is claimed is:

1. A control system for coordinating a plurality of machines for performing a plurality of types of earth-working operations on a worksite, the control system comprising:
a plurality of locating devices, each being configured to generate a signal indicative of a three-dimensional location of one of the plurality of machines, the signal being associated with one of the plurality of types of earth-working operations;
a display device; and
a controller in electronic communication with the plurality of locating devices and the display device and configured to:
determine a surface condition of the worksite based on the signal generated by each of the plurality of locating devices and corresponding to one or more of the plurality of types of earth-working operations; and
generate a map of the worksite on the display device, wherein the map is indicative of the surface condition of the worksite.

2. The control system of claim 1, wherein the controller is configured to generate graphical objects on the map indicative of areas of the worksite where each of the plurality of types of earth-working operations were respectively performed by the plurality of machines.

3. The control system of claim 1, wherein the plurality of types of earth-working operations includes one or more of a mixing operation, a dozing operation, a grading operation, and a compacting operation.

4. The control system of claim 1, wherein the controller is configured to generate graphical objects on the map indicative of the location of each of the plurality of machines.

5. The control system of claim 1, wherein the controller is configured to:
track a number of successive performances of a first type of earth-working operation on at least a portion of the worksite based on the signal generated by each of the plurality of locating devices; and
determine the surface condition of the worksite based further on the number of successive performances of the first type of earth-working operation.

6. The control system of claim 1, wherein the controller is configured to:
generate a three-dimensional as-built model of the worksite based on the signal generated by each of the plurality of locating devices; and
generate the map of the worksite based on a difference between the as-built model and a design model of the worksite stored in memory of the controller.

7. The control system of claim 6, wherein:
the controller is configured to determine a grade status of the worksite based on the difference between the as-built model and the design model of the worksite; and
the map of the worksite is further indicative of the grade status of the worksite.

8. The control system of claim 7, wherein the controller is configured to generate graphical objects on the map indicative of areas of the worksite that are at, above, or below a design grade associated with the design model.

9. The control system of claim 1, wherein:
the control system further includes a communication device electronically connected to the controller and configured to receive data from one or more off-board entities; and
the controller is configured to receive the signal from one or more of the plurality of locating devices via the communication device.

10. The control system of claim 1, wherein the controller is configured to automatically generate command signals communicable to one or more actuators based on the surface condition of the worksite, wherein each of the one or more actuators is configured to control an operational aspect of one of the plurality of machines.

11. A method of coordinating a plurality of machines for performing a plurality of types of earth-working operations on a worksite, the method comprising:
receiving a plurality of signals, each being indicative of a three-dimensional location of one of the plurality of machines and associated with one of the plurality of types of earth-working operations;
determining a surface condition of the worksite corresponding to one or more of the plurality of types of earth-working operations based on the plurality of signals; and
generating a map of the worksite on a display device, wherein the map is indicative of the surface condition of the worksite.

12. The method of claim 11, further including generating graphical objects on the map indicative of areas of the worksite where each of the plurality of types of earth-working operations were respectively performed by the plurality of machines, wherein the plurality of types of earth-working operations includes one or more of a mixing operation, a dozing operation, a grading operation, and a compacting operation.

13. The method of claim 11, further including generating graphical objects on the map indicative of the location of each of the plurality of machines.

14. The method of claim 11, further including:
tracking a number of successive performances of a first type of earth-working operation on at least a portion of the worksite based on the plurality of signals; and
determining the surface condition of the worksite based further on the number of successive performances of the first type of earth-working operation.

15. The method of claim 11, further including:
generating a three-dimensional as-built model of the worksite based on the plurality of signals; and
generating the map of the worksite based on a difference between the as-built model and a design model of the worksite.

16. The method of claim 15, wherein:
the method further includes determining a grade status of the worksite based on the difference between the as-built model and the design model of the worksite; and
the map of the worksite is further indicative of the grade status of the worksite.

17. The method of claim 16, further including generating graphical objects on the map indicative of areas of the worksite that are at, above, or below a design grade associated with the design model.

18. The method of claim 11, further including receiving one or more of the plurality of signals via a communication device configured to receive data from one or more off-board entities.

19. The method of claim 11, further including automatically generating command signals communicable to one or more actuators based on the surface condition of the worksite, wherein each of the one or more actuators is configured to control an operational aspect of one of the plurality of machines.

20. A control system for coordinating a plurality of machines for performing a plurality of types of earth-working operations on a worksite, the control system comprising:
a plurality of locating devices, each being configured to generate a signal indicative of a three-dimensional location of one of the plurality of machines, the signal being associated with one of the plurality of types of earth-working operations;
a display device; and
a controller in electronic communication with the plurality of locating devices and the display device and configured to:
generate a three-dimensional as-built model of the worksite based on the signal generated by each of the plurality of locating devices;
determine a difference between the as-built model and a design model of the worksite stored in memory of the controller;
determine a surface condition of the worksite based on the difference between the as-build model and the design model, the surface condition corresponding to one or more of the plurality of types of earth-working operations;
determine a grade status of the worksite based on the difference between the as-built model and the design model;
generate a map of the worksite on the display device, wherein the map is indicative of the surface condition and the grade status of the worksite; and
generate graphical objects on the map indicative of areas of the worksite where each of the plurality of types of earth-working operations were respectively performed by the plurality of machines.
